(19) United States
(12) Patent Application Publication
(10) Pub. No.: US 2009/0252545 A1
(43) Pub. Date: Oct. 8, 2009

(54) Image forming system and image forming apparatus

(75) Inventor: Takeshi Sasaki, Tokyo (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/385,235

(22) Filed: Apr. 2, 2009

(30) Foreign Application Priority Data
Apr. 4, 2008 (JP) 2008-098682
Jan. 21, 2009 (JP) 2009-011056

(51) Int. Cl. G03G 15/00

(52) U.S. Cl. 399/410

(57) ABSTRACT

An image forming system that binds sheets into a booklet inhibits Z-folding of a sheet and mixing of a sheet of a different size when a binding mode corresponding to a binding process other than a stapling process is selected by a user. When the Z-folding of a sheet and the mixing of a sheet of a different size are inhibited, the image forming system can release an inhibition of the Z-folding of a sheet and the mixing of a sheet of a different size depending on an instruction from a user.

### CROSS-REFERENCE TO RELATED APPLICATIONS

The present application claims priority to and incorporates by reference the entire contents of Japanese priority document 2008-098682 filed in Japan on Apr. 4, 2008 and Japanese priority document 2009-011056 filed in Japan on Jan. 21, 2009.

### BACKGROUND OF THE INVENTION

1. Field of the Invention

The present invention relates to an image forming apparatus and an image forming system having a function of binding sheets.

2. Description of the Related Art

Various bookbinding techniques such as tape binding, ring biding, and glue binding are used for making a booklet in an image forming system. In the tape binding, a booklet is made by binding a front cover, a spine, and a back cover together with an adhesive tape. In the ring binding, a plurality of holes are punched in binding edges of sheets and then metallic coils or plastic rings are put through the holes, whereby the sheets are bound into a booklet. In the glue binding, a booklet is made by wrapping one sheet cover that is divided into three sections to be a front cover, a spine, and a back cover around a sheet bundle, and gluing the sheet bundle at the spine of the sheet cover.

Recently, enhancement of bookbinding techniques for post processing on documents output from an image forming apparatus, such as a copier or a printer, or an image forming system including the image forming apparatus is increasingly demanded. In other words, a demand for devices that can perform more diverse post processing on documents is growing. To meet such demands, devices such as a sheet post processing device, a tape binding device, a ring binding device, and a glue binding device have been developed. Specifically, the sheet post processing device can perform saddle stitching in addition to side stapling, so that a so-called saddle-stitched booklet can be made by stapling a center portion of a sheet bundle and folding the sheet bundle by half at the stapled portion. The tape binding device can make a booklet by putting an adhesive tape to edges of aligned sheets, so that the aligned sheets are bound. The ring binding device can make a ring-bound booklet by punching holes in binding edges of sheets, aligning the sheets, and putting metallic coils or plastic rings through the holes. The glue binding device can make a booklet by wrapping one sheet cover that is divided into three sections to be a front cover, a spine, and a back cover around a sheet bundle, and gluing the sheet bundle at the spine of the sheet cover.

Meanwhile, a typical post processing apparatus attachable to the image forming apparatus has a Z-fold function as one standard function. The Z-fold function is used for folding a sheet in a Z-fold manner to a half size or the like. With the Z-fold function, it is possible to mix a sheet of A3 size in a booklet of sheets of A4 sizes by folding the sheet of A3 size in a Z-fold manner to an A4 size. However, because the degree of freedom in sheet sizes or the number of sheets to be bound is more limited in the tape binding, the ring binding, and the glue binding than in the conventional stapling for making a booklet, if a Z-folded sheet is mixed in sheets to be bound through the tape binding, the ring binding, and the glue binding, a sheet alignment failure or a sheet binding failure may occur during a sheet alignment process or a sheet binding process. Furthermore, depending on the number of Z-folded sheets mixed in a booklet or a position of a Z-folded sheet in the booklet, various problems may occur such that the booklet may not be conveyed in a desired manner, sheets are turned over, or a paper jam occurs. Moreover, if a sheet of a different size is mixed in a booklet without being Z-folded, the sheet alignment failure or the sheet binding failure may occur.

With regard to the Z-fold function, a technology for preventing a Z-folded sheet from being cut off at a folded line when trimming a circumference of a sheet bundle containing the Z-folded sheet is disclosed in Japanese Patent No. 3864653. Furthermore, Japanese Patent No. 3834809 discloses a technology for preventing occurrence of a paper jam in a sheet conveying path or a sheet stacking area where sheets are stacked one on top of the other. Specifically, when a sheet is Z-folded, the Z-folded sheet is not allowed to be stacked on other sheets. Therefore, it is possible to prevent a sheet conveying path upstream of the Z-folded sheet in the sheet stacking area from being blocked and occurrence of a paper jam in the sheet conveying path and the sheet stacking area caused by the Z-folded sheet.

Furthermore, Japanese Patent Application Laid-open No. 2005-266245 discloses a technology for effectively using a time during a Z-folding process by discharging sheets that are not to be Z-folded to a post processing apparatus in advance of a sheet to be Z-folded.

However, with the conventional Z-folding technologies, while Z-folded sheets can be mixed in a booklet without causing any problems depending on the number of the Z-folded sheets or positions of the Z-folded sheets in the booklet, the image forming system cannot effectively change settings for such a case.

### SUMMARY OF THE INVENTION

It is an object of the present invention to at least partially solve the problems in the conventional technology.

According to one aspect of the present invention, there is provided an image forming system that has at least one binding mode for binding sheets to make a booklet. The image forming system includes an image forming apparatus that forms an image on a sheet, the image forming apparatus including an operating unit that receives an input of a binding mode; a Z-folding device including a Z-folding unit that folds a sheet into Z-fold depending on an input binding mode; a sheet post processing device including a binding unit that performs a stapling process on sheets depending on the input binding mode; and at least one binding device including a binding unit that performs a binding process other than the stapling process on the sheets depending on the input binding mode. The image forming apparatus further includes a control unit that, when it is determined that the input binding mode is a binding mode corresponding to a binding process other than the stapling process, inhibits the Z-folding unit from folding a sheet into Z-fold.

Furthermore, according to another aspect of the present invention, there is provide an image forming apparatus including an operating unit that receives an input of a binding mode and an image forming unit that forms an image on a sheet. The image forming apparatus is connected to a Z-folding device, a sheet post processing device, and at least one binding device. The Z-folding device includes a Z-folding unit that folds a sheet into Z-fold. The sheet post processing device includes a binding unit that performs a stapling process on sheets. The binding device includes a binding unit that performs a binding process other than the stapling process on the sheets depending on an input binding mode. The image forming apparatus further comprises a control unit that controls the Z-folding device, the sheet post processing device, and the binding device depending on the input binding mode. When it is determined that the input binding mode is a binding mode corresponding to a binding process other than the stapling process, the control unit inhibits the Z-folding unit from folding a sheet into Z-fold.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image forming system according to an embodiment of the present invention;

FIG. 2 is a schematic diagram of a ring binding device in the image forming system shown in FIG. 1;

FIG. 3 is a schematic diagram of a ring-bound booklet made by the image forming system shown in FIG. 1;

FIG. 4 is a flowchart of an operation for inhibiting Z-folding of a sheet and mixing of a sheet of a different size when a binding mode for tape binding, ring binding, or glue binding other than stapling is selected;

FIG. 5 is a flowchart of a process procedure in which a user releases an inhibition of Z-folding of a sheet, mixing of a sheet of a different size, mixing of a Z-folded sheet in a front cover or a back cover, and mixing of a sheet of a different size in the front cover or the back cover when a binding mode for tape binding, ring binding, or glue binding other than stapling is selected in the image forming system shown in FIG. 1;

FIG. 6 is a flowchart of a process in which a serviceman releases an inhibition of Z-folding of a sheet, mixing of a sheet of a different size, mixing of a Z-folded sheet in a front cover or a back cover, and mixing of a sheet of a different size in the front cover or the back cover when a binding mode for tape binding, ring binding, or glue binding other than stapling is selected in the image forming system shown in FIG. 1;

FIGS. 7A and 7B are schematic diagrams of examples of an operation panel for receiving an input to enable mixing of a Z-folded sheet in the image forming apparatus shown in FIG. 1;

FIG. 8 is a schematic diagram of examples of a ring-bound booklet that contains Z-folded sheets;

FIG. 9 is a flowchart of a process procedure in which a user releases an inhibition of Z-folding of a sheet and mixing of a sheet of a different size when a binding mode for tape binding, ring binding, or glue binding other than stapling is selected in the image forming system shown in FIG. 1; and

FIG. 10 is a flowchart of a process procedure in which a serviceman releases an inhibition of Z-folding of a sheet and mixing of a sheet of a different size when a binding mode for tape binding, ring binding, or glue binding other than stapling is selected in the image forming system shown in FIG. 1.

### DETAILED DESCRIPTION OF THE PREFERRED EMBODIMENTS

Exemplary embodiments of the present invention are explained in detail below with reference to the accompanying drawings.

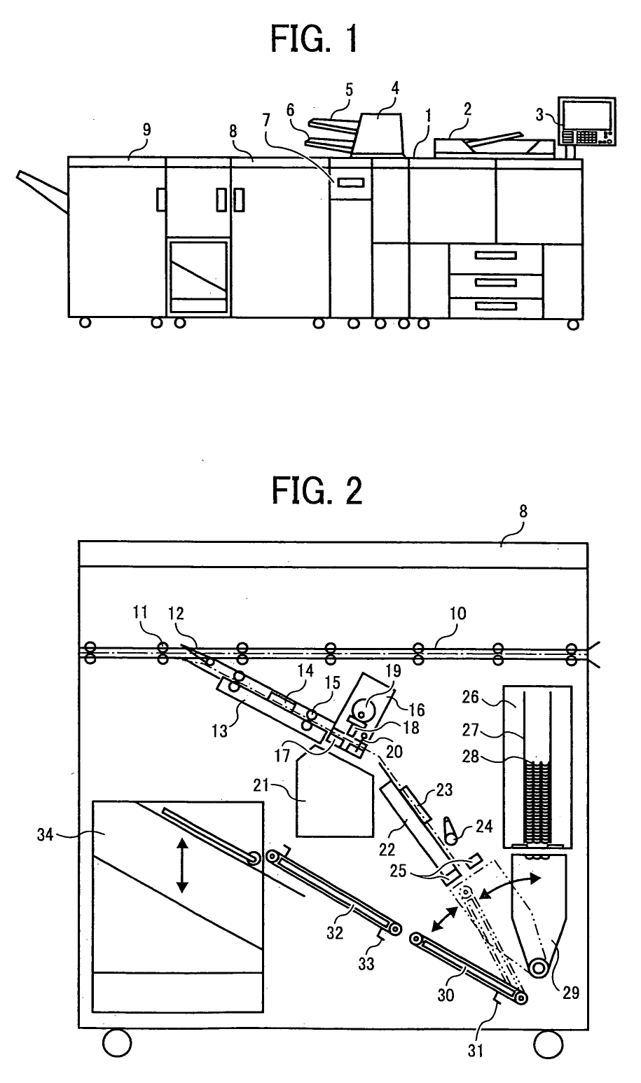

FIG. 1 is a schematic diagram of an image forming system according to an embodiment of the present invention. The configuration of the image forming system according to the embodiment is described in detail below with reference to FIG. 1. The image forming system according to the embodiment includes an image forming apparatus 1, an automatic document feeder (ADF) 2, an operation panel 3 having a display device, an inserter 4, a sheet tray 5, a sheet tray 6, a Z-folding device 7, a ring binding device 8, and a sheet finisher 9.

In the embodiment, it is assumed that the image forming apparatus 1 is a multifunction peripheral (MFP). The image forming apparatus 1 includes the ADF 2 and the operation panel 3 having the display device. The operation panel 3 receives an input of a selection of a binding mode or the like from a user. Examples of the binding mode include a ring binding mode, a tape binding mode, a glue binding mode, and a stapler binding mode. The operation panel 3 also receives an input of a Z-fold mode or a mixed-size mode, which will be described later.

The inserter 4 is connected to a downstream side of the ADF 2. The inserter 4 includes the sheet trays 5 and 6, and inserts a sheet on which an image has been formed or a sheet that cannot pass through the image forming apparatus 1 in a booklet. The Z-folding device 7 is connected to a downstream side of the inserter 4. The Z-folding device 7 folds a sheet into Z-fold such that an A3 portrait sheet is Z-folded to an A4 landscape sheet. The ring binding device 8 is connected to a downstream side of the Z-folding device 7. The ring binding device 8 punches a plurality of holes in sheets to be ring bound into a booklet, aligns the sheets, and binds the sheets with rings. The sheet finisher 9 is connected to the most downstream side of the image forming system. Detailed explanation about functions of the sheet finisher 9 is omitted in this document. The sheet finisher 9 includes a punching device (not shown) that can punch holes as many as one to four and a stapling device (not shown), and performs various stapling processes and sheet aligning processes. In the following description, an example is used in which the image forming system includes a binding device that performs ring binding. However, the image forming system can include one or more binding devices that perform tape binding, glue binding, and the like.

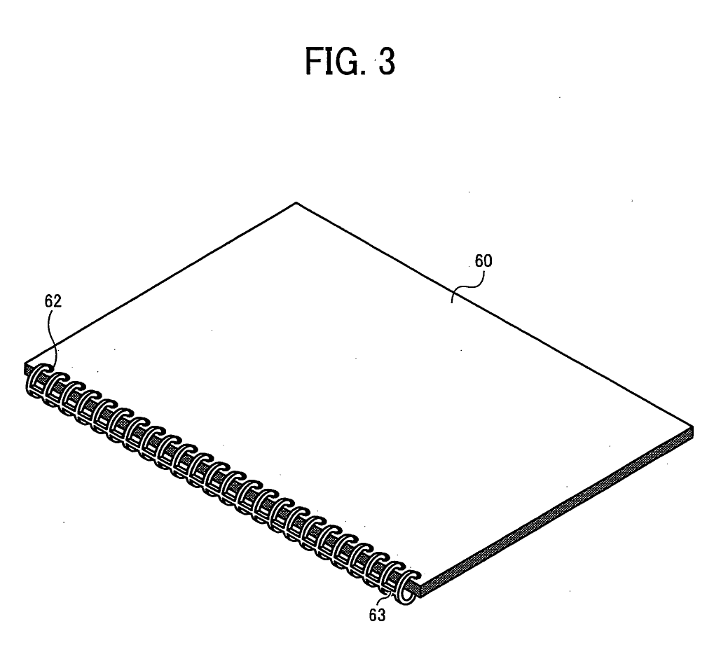

FIG. 2 is a schematic diagram of the ring binding device 8 in the image forming system shown in FIG. 1. The configuration of the ring binding device 8 is described in detail below with reference to FIG. 2. The ring binding device 8 includes a horizontal conveying path 10, a pair of reverse rollers 11, a switching claw 12, an alignment tray 13, a jogger 14, a pair of conveying rollers 15, a punching unit 16, a die 17, a punch 18, a cam 19, an abutment stopper 20, an alignment tray 22, a lateral alignment jogger 23, a tapping roller 24, clamps 25, a ring-cartridge storage unit 26, a ring cartridge 27, rings 28, a ring binding unit 29, a sheet-bundle conveying unit 30, a discharge claw 31, a last-sheet-bundle conveying unit 32, and a stack tray 34.

The horizontal conveying path 10 conveys a sheet fed from the image forming apparatus 1 and the inserter 4. When the sheet is not to be ring bound, the horizontal conveying path 10 conveys the sheet in a horizontal direction towards the sheet finisher 9 connected to the downstream side of the ring binding device 8. When the sheet is to be ring bound, the reverse rollers 11 arranged downstream of the horizontal conveying path 10 switch over a conveying direction of the sheet by switching the switching claw 12, whereby the sheet is conveyed to a punching area that is obliquely arranged below the horizontal conveying path 10.

In the punching area, the jogger 14 aligns lateral sides of the sheet on the alignment tray 13, and the sheet is guided such that a leading end of the sheet abuts the abutment stopper 20, whereby a position of the sheet is set in the lateral direction and in the conveying direction. When the leading end of the sheet abuts the abutment stopper 20, the conveying rollers 15 having torque limiters apply conveying force to the sheet to suppress damage to the leading end of the sheet. When the position of the sheet is set, the cam 19 in the punching unit 16 is rotated to press the punch 18 downward such that the punch 18 and the die 17 sandwich the sheet, whereby holes are punched in the sheet. The punching unit 16 is configured to punch a plurality of holes for ring binding. After the holes are punched in the sheet, the abutment stopper 20 is released, and the sheet is conveyed downward.

That is, the sheet is conveyed to an alignment area. In the alignment area, a plurality of sheets to be bound into one booklet is received one by one, and each sheet is aligned and stacked one on top of the other. The alignment tray 22 includes the lateral alignment jogger 23 and the tapping roller 24 that taps the sheet in the conveying direction. A fence (not shown) aligns the sheet in the conveying direction and the lateral alignment jogger 23 aligns the sheet in the lateral direction. When the sheets to be bound into one booklet is stacked and aligned on the alignment tray 22, the clamps 25 hold edges near binding edges of the sheets while pressing the edges.

The ring-cartridge storage unit 26 accommodates the ring cartridge 27. The ring cartridge 27 accommodates the rings 28. Specifically, in the embodiment, the rings 28 are plastic rings whose circumferences are divided into three parts. The ring binding unit 29 rotates until it comes below the ring cartridge 27, and then receives the rings 28. When the ring binding unit 29 receives one of the rings 28, the ring binding unit 29 rotates until it comes below the clamps 25, and then puts the ring 28 through one of the holes punched in a lower end of the sheets. Then, a binding unit (not shown) closes the ring 28.

When the sheet-bundle conveying unit 30 rotates until it comes below the clamps 25, the clamps 25 are released. Accordingly, the discharge claw 31 arranged on a belt of the sheet-bundle conveying unit 30 receives the ring-bound booklet, whereby the booklet is passed over to the sheet-bundle conveying unit 30. The sheet-bundle conveying unit 30 then rotates counterclockwise until it comes to a position in the substantially same line with the last-sheet-bundle conveying unit 32. Subsequently, the sheet-bundle conveying unit 30 passes the booklet to the last-sheet-bundle conveying unit 32 by using the discharge claw 31 arranged on the belt of the sheet-bundle conveying unit 30. The last-sheet-bundle conveying unit 32 conveys the booklet by using a discharge claw 33 arranged on a belt of the last-sheet-bundle conveying unit 32, and then discharges the booklet to the stack tray 34.

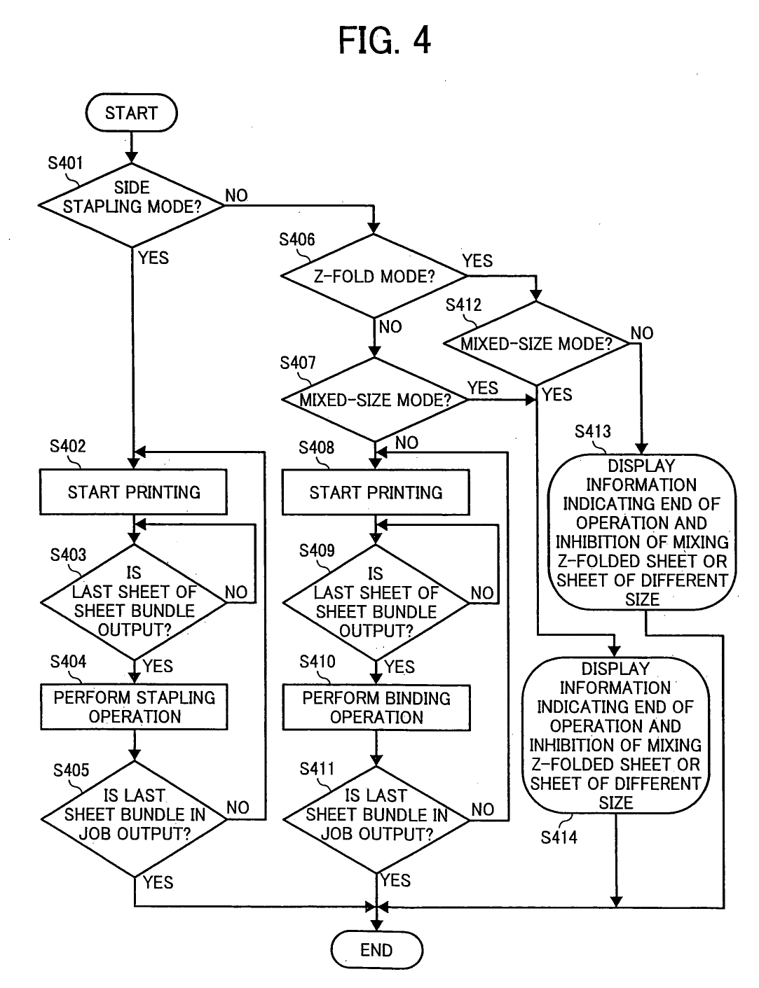

FIG. 3 is a schematic diagram of a ring-bound booklet made by the image forming system shown in FIG. 1. A plurality of holes 62 are punched in a sheet bundle 60 and rings 63 are put through the holes 62 so that the ring-bound booklet is made.

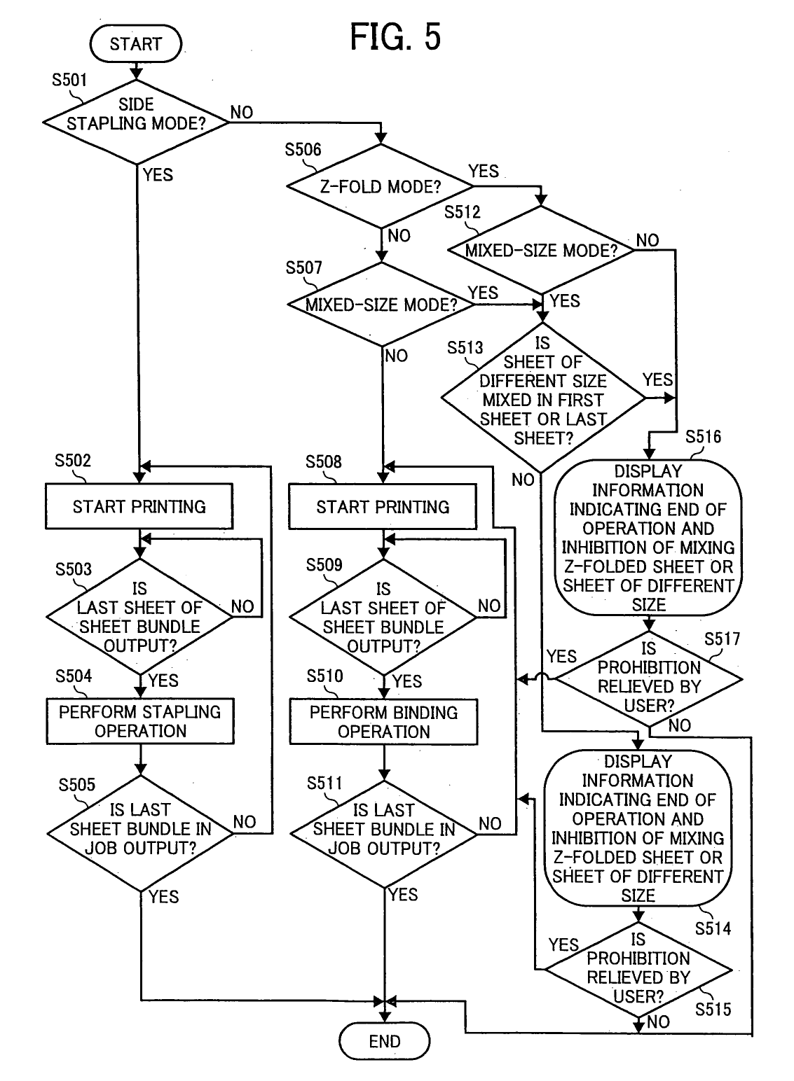

FIG. 4 is a flowchart of an operation according to a first embodiment of the present invention for inhibiting Z-folding of a sheet and mixing of a sheet of a different size when a binding mode for tape binding, ring binding, or glue binding other than stapling is selected in the image forming system shown in FIG. 1. A process procedure of the operation is described in detail below with reference to FIG. 4.

The image forming apparatus 1 determines whether a side stapling mode is selected as a binding mode based on an input of a selection of the binding mode from a user via the operation panel 3 (Step S401). When determining that the selected binding mode is the side stapling mode (YES at Step S401), the image forming apparatus 1 starts a printing process (Step S402). The image forming apparatus 1 then determines whether a last sheet of a sheet bundle is output (Step S403). When determining that the last sheet of the sheet bundle is not output (NO at Step S403), process control remains at Step S403 and the printing process is repeated until the last sheet of the sheet bundle is output. When the last sheet of the sheet bundle is output (YES at Step S403), the sheet finisher 9 performs a stapling operation (Step S404). Then, the image forming apparatus 1 determines whether a last sheet bundle in a job is output (Step S405). When the last sheet bundle in the job is not output (NO at Step S405), the processes at Steps S402 to S404 are repeated until the last sheet bundle in the job is output. When the last sheet bundle in the job is output (YES at Step S405), the image forming system ends the operation.

On the other hand, when determining that the side stapling mode is not selected as the binding mode (NO at Step S401), the image forming apparatus 1 determines whether a Z-fold mode is selected (Step S406). When determining that the Z-fold mode is not selected (NO at Step S406), the image forming apparatus 1 determines whether a mixed-size mode is selected (Step S407). When determining that the mixed-size mode is selected (YES at Step S407), the image forming system ends the operation and displays information indicating an end of the operation by the image forming system and an inhibition of mixing of a sheet of a different size (Step S414). When determining that the mixed-size mode is not selected (NO at Step S407), the image forming apparatus 1 starts a printing process (Step S408).

When starting the printing process, the image forming apparatus 1 determines whether the last sheet of the sheet bundle is output (Step S409). When determining that the last sheet of the sheet bundle is not output (NO at Step S409), process control remains at Step S409 and the printing process is repeated until the last sheet of the sheet bundle is output. When the last sheet of the sheet bundle is output (YES at Step S409), a device for a corresponding binding operation performs the binding operation other than a side stapling operation (Step S410). Then, the image forming apparatus 1 determines whether the last sheet bundle in the job is output (Step S411). When the last sheet bundle in the job is not output (NO at Step S411), the processes at Steps S408 to S410 are repeated until the last sheet bundle in the job is output. When the last sheet bundle in the job is output (YES at Step S411), the image forming system ends the operation.

When determining that the Z-fold mode is selected in the process at Step S406 (YES at Step S406), the image forming apparatus 1 determines whether the mixed-size mode is selected (Step S412). When determining that the mixed-size mode is not selected (NO at Step S412), the image forming system ends the operation and displays information indicating an end of the operation by the image forming system and an inhibition of mixing of a Z-folded sheet (Step S413). Similarly, when determining that the mixed-size mode is selected (YES at Step S412), the image forming system ends the operation and displays information indicating an end of the operation by the image forming system and an inhibition of mixing of a Z-folded sheet (Step S414).

According to the first embodiment, when a user selects a binding mode for tape binding, ring binding, or glue binding other than stapling, and if the Z-fold mode or the mixed-size mode is selected or is to be selected, the Z-fold mode and the mixed-size mode are inhibited. That is, the user is not allowed to select the Z-fold mode and the mixed-size mode. Therefore, it is possible to provide the image forming system with high functionalities that can prevent an alignment failure or a binding failure of the sheet bundle 60.

In the first embodiment, an example in which the Z-fold mode and the mixed-size mode are inhibited when a user selects a binding mode other than the stapling is described. However, the present invention is not limited to this example. For example, it is applicable to configure such that all sheets in a booklet are not allowed to be Z-folded and mixing of a sheet of a different size in the booklet is inhibited only when a front cover or a back cover of the booklet is Z-folded or the size of the front cover or the back cover is different from those of other sheets. Furthermore, it is applicable to configure such that z-folding and mixing of a sheet of a different size are inhibited only in the front cover or the back cover of the booklet. The determination about whether a Z-folded sheet or a sheet of a different size is mixed in the front cover or the back cover can be made based on an input from a user or by the image forming apparatus.

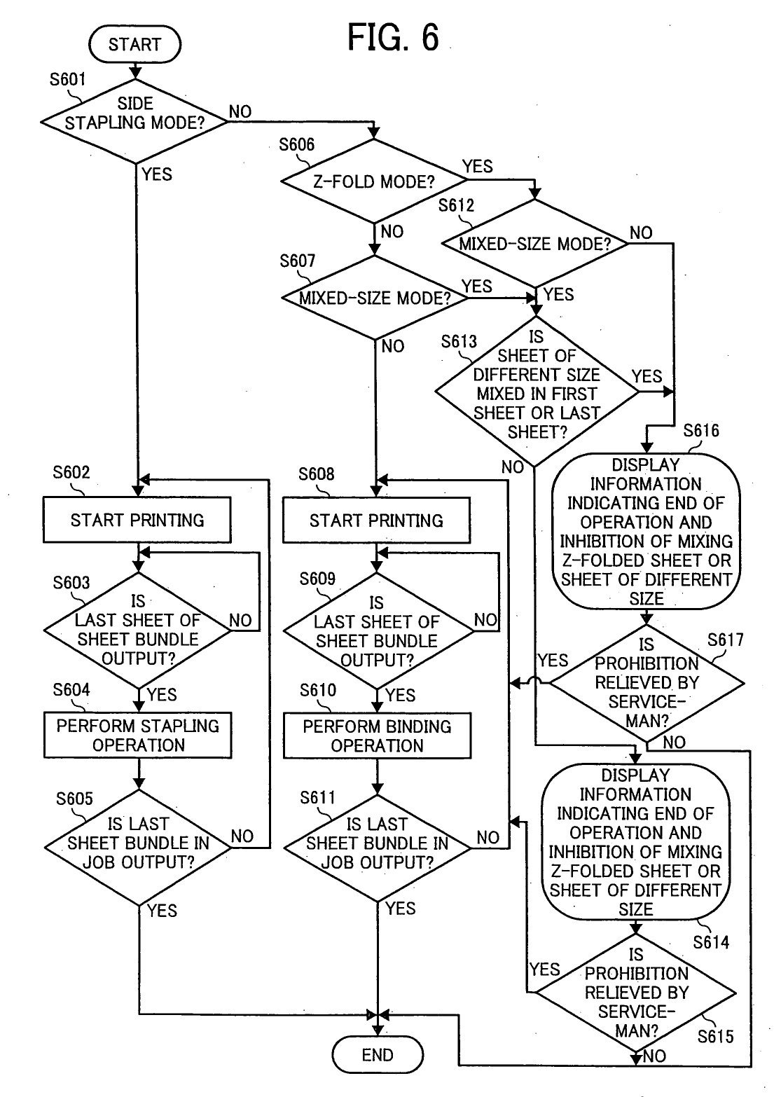

FIG. 5 is a flowchart of a process procedure according to a second embodiment of the present invention, in which a user releases an inhibition of Z-folding of a sheet, mixing of a sheet of a different size, mixing of a Z-folded sheet in a front cover or a back cover, and mixing of a sheet of a different size in the front cover or the back cover when the user selects a binding mode for tape binding, ring binding, or glue binding other than stapling in the image forming system shown in FIG. 1. The process procedure is described in detail below with reference to FIG. 5.

The image forming apparatus 1 determines whether a side stapling mode is selected as a binding mode based on an input of a selection of the binding mode from a user via the operation panel 3 (Step S501). When determining that the selected binding mode is the side stapling mode (YES at Step S501), the image forming apparatus 1 starts a printing process (Step S502). The image forming apparatus 1 then determines whether a last sheet of a sheet bundle is output (Step S503). When determining that the last sheet of the sheet bundle is not output (NO at Step S503), process control remains at Step S503 and the printing process is repeated until the last sheet of the sheet bundle is output. When the last sheet of the sheet bundle is output (YES at Step S503), the sheet finisher 9 performs a stapling operation (Step S504). Then, the image forming apparatus 1 determines whether a last sheet bundle in a job is output (Step S505). When the last sheet bundle in the job is not output (NO at Step S505), the processes at Steps S502 to S504 are repeated until the last sheet bundle in the job is output. When the last sheet bundle in the job is output (YES at Step S505), the image forming system ends the operation.

On the other hand, when determining that the side stapling mode is not selected as the binding mode (NO at Step S501), the image forming apparatus 1 determines whether a Z-fold mode is selected (Step S506). When determining that the Z-fold mode is not selected (NO at Step S506), the image forming apparatus 1 determines whether a mixed-size mode is selected (Step S507). When determining that the mixed-size mode is not selected (NO at Step S507), the image forming apparatus 1 starts a printing process (Step S508).

When starting the printing process, the image forming apparatus 1 determines whether the last sheet of the sheet bundle is output (Step S509). When determining that the last sheet of the sheet bundle is not output (NO at Step S509), process control remains at Step S509 and the printing process is repeated until the last sheet of the sheet bundle is output. When the last sheet of the sheet bundle is output (YES at Step S509), a device for a corresponding binding operation performs the binding operation other than a side stapling operation (Step S510). Then, the image forming apparatus 1 determines whether the last sheet bundle in the job is output (Step S511). When the last sheet bundle in the job is not output (NO at Step S511), the processes at Steps S508 to S510 are repeated until the last sheet bundle in the job is output. When the last sheet bundle in the job is output (YES at Step S511), the image forming system ends the operation.

On the other hand, in the process at Step S507, when determining that the mixed-size mode is selected (YES at Step S507), the image forming apparatus 1 determines whether a sheet of a different size is mixed in a first sheet or a last sheet (a front cover or a back cover) (Step S513). When the sheet of the different size is not mixed in the first sheet or the last sheet (NO at Step S513), the image forming system ends the operation and displays information indicating an end of the operation by the image forming system and an inhibition of mixing of the sheet of the different size (Step S514). The image forming apparatus 1 displays a selection input screen for instructing the user to select whether to release an inhibition of the mixed-size mode on a display unit (not shown) so that the user is instructed to select whether to release the inhibition of the mixed-size mode (Step S515). When the user inputs the instruction for relieving the inhibition of the mixed-size mode (YES at Step S515), process control returns to Step S508, that is, the image forming apparatus 1 starts the printing process (Step S508). Then, the processes at Steps S509 to S511 are repeated in the same manner as described above. When the user does not input the instruction for relieving the inhibition of the mixed-size mode (NO at Step S515), the image forming system ends the operation.

In the process at Step S513, when determining that the sheet of the different size is mixed in the first sheet or the last sheet (YES at Step S513), the image forming system ends the operation and displays information indicating an end of the operation by the image forming system and an inhibition of mixing of the sheet of the different size (Step S516). Then, the image forming apparatus 1 displays the selection input screen for instructing the user to select whether to release an inhibition of the mixed-size mode on the display unit, so that the user is instructed to select whether to release the inhibition of the mixed-size mode (Step S517). When the user inputs the instruction for relieving the inhibition of the mixed-size mode (YES at Step S517), process control returns to Step S508, that is, the image forming apparatus 1 starts the printing process (Step S508). Then, the processes at Steps S509 to S511 are repeated in the same manner as described above. When the user does not input the instruction for relieving the inhibition of the mixed-size mode (NO at Step S517), the image forming system ends the operation.

When determining that the Z-fold mode is selected in the process at Step S506 (YES at Step S506), the image forming apparatus 1 determines whether the mixed-size mode is selected (Step S512). When determining that the mixed-size mode is not selected (NO at Step S512), the image forming system ends the operation and displays information indicating an end of the operation by the image forming system and an inhibition of mixing of a Z-folded sheet (Step S516).

Then, the image forming apparatus 1 displays a selection input screen for instructing the user to select whether to release an inhibition of the Z-fold mode on the display unit, so that the user is instructed to select whether to release the inhibition of the Z-fold mode (Step S517). When the user inputs the instruction for relieving the inhibition of the Z-fold mode (YES at Step S517), process control returns to Step S508, that is, the image forming apparatus 1 starts the printing process (Step S508). Then, the processes at Steps S509 to S511 are repeated in the same manner as described above. When the user does not input the instruction for relieving the inhibition of the Z-fold mode (NO at Step S517), the image forming system ends the operation.

On the other hand, in the process at Step S512, when determining that the mixed-size mode is selected (YES at Step S512), the image forming apparatus 1 determines whether a Z-folded sheet or a sheet of a different size is mixed in a first sheet or a last sheet (a front cover or a back cover) (Step S513). When the Z-folded sheet or the sheet of the different size is not mixed in the first sheet or the last sheet (NO at Step S513), the image forming system ends the operation and displays information indicating an end of the operation by the image forming system and an inhibition of mixing of a Z-folded sheet or a sheet of a different size (Step S514).

Then, the image forming apparatus 1 displays a selection input screen for instructing the user to select whether to release an inhibition of the Z-fold mode or the mixed-size mode on the display unit, so that the user is instructed to select whether to release the inhibition of the Z-fold mode or the mixed-size mode (Step S515). When the user inputs the instruction for relieving the inhibition of the Z-fold mode or the mixed-size mode (YES at Step S515), process control returns to Step S508, that is, the image forming apparatus 1 starts the printing process (Step S508). Then, the processes at Steps S509 to S511 are repeated in the same manner as described above. When the user does not input the instruction for relieving the inhibition of the Z-fold mode or the mixed-size mode (NO at Step S515), the image forming system ends the operation.

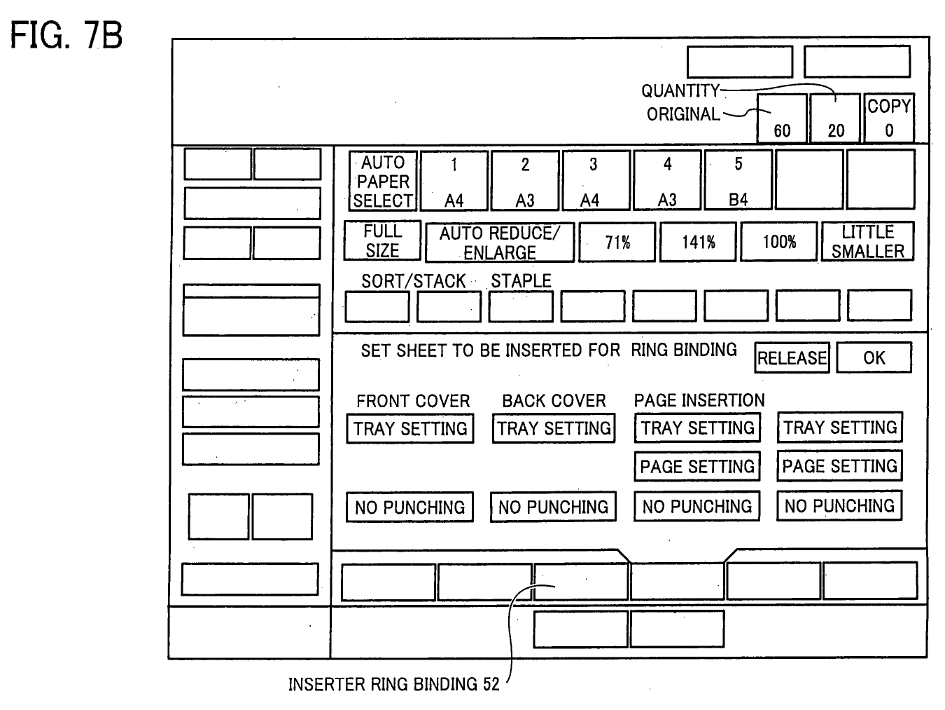

FIGS. 7A and 7B are schematic diagrams of examples of the operation panel 3 that receives an input for enabling mixing of a Z-folded sheet from a user. The operation for relieving the inhibition of Z-folding of a sheet or mixing of a sheet of a different size by the user can be performed through an input operation by touching buttons on a touch panel of a display screen 50 of the operation panel 3 that has the display device in the image forming apparatus 1.

FIG. 7A is a schematic diagram of a screen for a special setting of the ring binding unit 29. By touching a “RING BINDING SPECIAL SETTING” tab 51 arranged at a bottom portion of the screen, a screen to be operated is changed such that the screen shown in FIG. 7A is displayed. A user can set various settings about a sheet feed tray, whether to copy, or whether to punch a hole for each page of a booklet to be processed by the ring binding unit 29. In the second embodiment, an input key for enabling mixing of a Z-folded sheet is arranged on this setting screen. However, it is applicable to integrate the input key for enabling the mixing of a Z-folded sheet and an input key for enabling mixing of a sheet of a different size to a shared input key. It is also applicable to arrange the input keys for enabling the mixing of a Z-folded sheet and a sheet of a different size individually.

FIG. 7B is a schematic diagram of a setting screen for a sheet to be inserted from the inserter 4. By touching an “INSERTIER RING BINDING” tab 52 arranged at a bottom portion of the screen, a screen to be operated is changed such that the screen shown in FIG. 7B is displayed. A user can change settings for punching holes in a sheet to be inserted from the inserter 4 or set a page to be inserted.

According to the second embodiment, when a user selects a binding mode for tape binding, ring binding, or glue binding other than stapling, Z-folding of a sheet, mixing of a sheet of a different size, mixing of a Z-folded sheet in a front cover or a back cover, and mixing of a sheet of a different size in the front cover or the back cover are inhibited by default. However, a user can release the inhibition through an operation for relieving the inhibition of the Z-folding of a sheet and mixing of a sheet of a different size. Therefore, it is possible to provide the image forming system with high functionalities that can enable the Z-folding of a sheet, the mixing of a sheet of a different size, the mixing of a Z-folded sheet in a front cover or a back cover, and the mixing of a sheet of a different size in the front cover or the back cover when the sheet bundle 60 has a page structure that can hardly cause an alignment failure or a binding failure.

In the second embodiment, an example in which a user performs an operation for relieving the inhibition of mixing of a Z-folded sheet and a sheet of a different size via the operation panel 3 is described. However, the present invention is not limited to this example, and the same operation can be performed through a unit that is generally operated by the user.

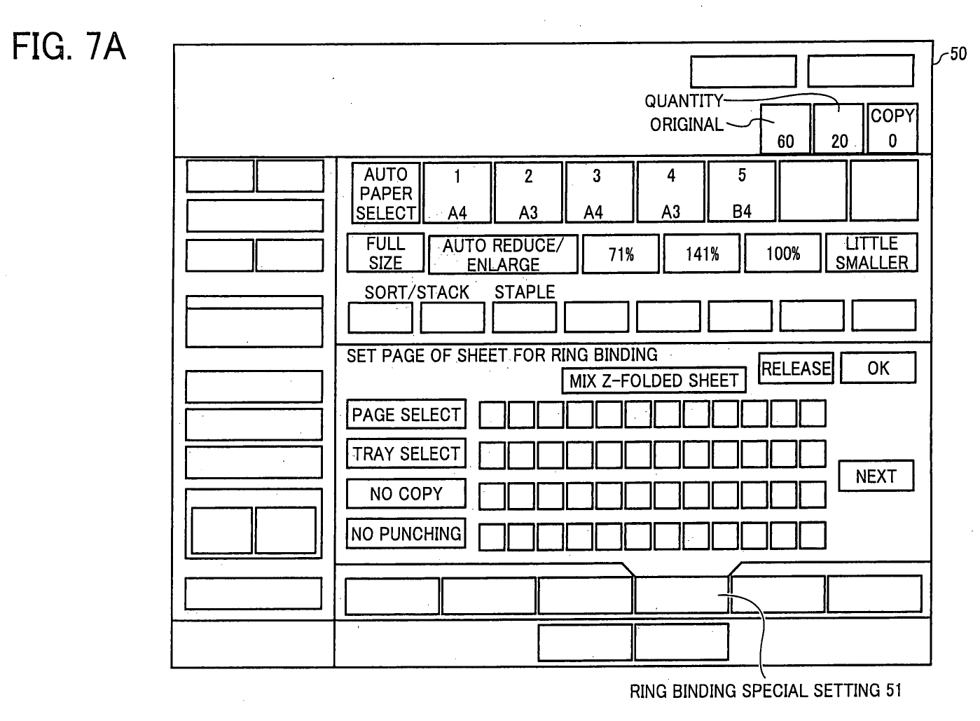

FIG. 6 is a flowchart of a process procedure according to a third embodiment of the present invention, in which a serviceman releases an inhibition of Z-folding of a sheet, mixing of a sheet of a different size, mixing of a Z-folded sheet in a front cover or a back cover, and mixing of a sheet of a different size in the front cover or the back cover when the user selects a binding mode for tape binding, ring binding, or glue binding other than stapling in the image forming system shown in FIG. 1. The process procedure is described in detail below with reference to FIG. 6.

The image forming apparatus 1 determines whether a side stapling mode is selected as a binding mode based on an input of a selection of the binding mode input via the operation panel 3 (Step S601). When determining that the selected binding mode is the side stapling mode (YES at Step S601), the image forming apparatus 1 starts a printing process (Step S602). The image forming apparatus 1 then determines whether a last sheet of a sheet bundle is output (Step S603). When determining that the last sheet of the sheet bundle is not output (NO at Step S603), process control remains at Step S603 and the printing process is repeated until the last sheet of the sheet bundle is output. When the last sheet of the sheet bundle is output (YES at Step S603), the sheet finisher 9 performs a stapling operation (Step S604). Then, the image forming apparatus 1 determines whether a last sheet bundle in a job is output (Step S605). When the last sheet bundle in the job is not output (NO at Step S605), the processes at Steps S602 to S604 are repeated until the last sheet bundle in the job is output. When the last sheet bundle in the job is output (YES at Step S605), the image forming system ends the operation.

On the other hand, when determining that the side stapling mode is not selected as the binding mode (NO at Step S601), the image forming apparatus 1 determines whether a Z-fold mode is selected (Step S606). When determining that the Z-fold mode is not selected (NO at Step S606), the image forming apparatus 1 determines whether a mixed-size mode is selected (Step S607). When determining that the mixed-size mode is not selected (NO at Step S607), the image forming apparatus 1 starts a printing process (Step S608).

When starting the printing process, the image forming apparatus 1 determines whether the last sheet of the sheet bundle is output (Step S609). When determining that the last sheet of the sheet bundle is not output (NO at Step S609), process control remains at Step S609 and the printing process is repeated until the last sheet of the sheet bundle is output. When the last sheet of the sheet bundle is output (YES at Step S609), a device for a corresponding binding operation performs the binding operation other than a side stapling operation (Step S610). Then, the image forming apparatus 1 determines whether the last sheet bundle in the job is output (Step S611). When the last sheet bundle in the job is not output (NO at Step S611), the processes at Steps S608 to S610 are repeated until the last sheet bundle in the job is output. When the last sheet bundle in the job is output (YES at Step S611), the image forming system ends the operation.

On the other hand, in the process at Step S607, when determining that the mixed-size mode is selected (YES at Step S607), the image forming apparatus 1 determines whether a sheet of a different size is mixed in a first sheet or a last sheet (Step S613). When the sheet of the different size is not mixed in the first sheet or the last sheet (NO at Step S613), the image forming system ends the operation and displays information indicating an end of the operation by the image forming system and an inhibition of mixing of a sheet of a different size (Step S614). The image forming apparatus 1 displays a selection input screen for instructing a serviceman to select whether to release an inhibition of the mixed-size mode on a display unit (not shown), so that the serviceman is instructed to select whether to release the inhibition of the mixed-size mode (Step S615). When the serviceman inputs the instruction for relieving the inhibition of the mixed-size mode (YES at Step S615), process control returns to Step S608, that is, the image forming apparatus 1 starts the printing process (Step S608). Then, the processes at Steps S609 to S611 are repeated in the same manner as described above. When the serviceman does not input the instruction for relieving the inhibition of the mixed-size mode (NO at Step S615), the image forming system ends the operation.

In the process at Step S613, when determining that the sheet of the different size is mixed in the first sheet or the last sheet (YES at Step S613), the image forming system ends the operation and displays information indicating an end of the operation by the image forming system and an inhibition of mixing of the sheet of the different size (Step S616). Then, the image forming apparatus 1 instructs the serviceman to select whether to release an inhibition of the mixed-size mode (Step S617). When the serviceman inputs an instruction for relieving the inhibition of the mixed-size mode (YES at Step S617), process control returns to Step S608, that is, the image forming apparatus 1 starts the printing process (Step S608). Then, the processes at Steps S609 to S611 are repeated in the same manner as described above. When the serviceman does not input the instruction for relieving the inhibition of the mixed-size mode (NO at Step S617), the image forming system ends the operation.

When determining that the Z-fold mode is selected in the process at Step S606 (YES at Step S606), the image forming apparatus 1 determines whether the mixed-size mode is selected (Step S612). When determining that the mixed-size mode is not selected (NO at Step S612), the image forming system ends the operation and displays information indicating an end of the operation by the image forming system and an inhibition of mixing of a Z-folded sheet (Step S616).

Then, the image forming apparatus 1 instructs the serviceman to select whether to release an inhibition of the Z-fold mode (Step S617). When the serviceman inputs an instruction for relieving the inhibition of the Z-fold mode (YES at Step S617), process control returns to Step S608, that is, the image forming apparatus 1 starts the printing process (Step S608). Then, the processes at Steps S609 to S611 are repeated in the same manner as described above. When the serviceman does not input the instruction for relieving the inhibition of the Z-fold mode (NO at Step S617), the image forming system ends the operation.

On the other hand, in the process at Step S612, when determining that the mixed-size mode is selected (YES at Step S612), the image forming apparatus 1 determines whether a Z-folded sheet or a sheet of a different size is mixed in a first sheet or a last sheet (a front cover or a back cover) (Step S613). When the Z-folded sheet or the sheet of the different size is not mixed in the first sheet or the last sheet (NO at Step S613), the image forming system ends the operation and displays information indicating an end of the operation by the image forming system and an inhibition of mixing of a Z-folded sheet or a sheet of a different size (Step S614).

Then, the image forming apparatus 1 instructs a serviceman to select whether to release an inhibition of the Z-fold mode or the mixed-size mode (Step S615). When the serviceman inputs an instruction for relieving the inhibition of the Z-fold mode or the mixed-size mode (YES at Step S615), process control returns to Step S608, that is, the image forming apparatus 1 starts the printing process (Step S608). Then, the processes at Steps S609 to S611 are repeated in the same manner as described above. When the serviceman does not input the instruction for relieving the inhibition of the Z-fold mode or the mixed-size mode (NO at Step S615), the image forming system ends the operation.

According to the third embodiment, when a binding mode for tape binding, ring binding, or glue binding other than stapling is selected, Z-folding of a sheet, mixing of a sheet of a different size, mixing of a Z-folded sheet in a front cover or a back cover, and mixing of a sheet of a different size in the front cover or the back cover are inhibited by default. However, a serviceman can release the inhibition through an operation for relieving the inhibition of the Z-folding of a sheet and mixing of a sheet of a different size. Therefore, it is possible to provide the image forming system with high functionalities that can enable the Z-folding of a sheet, the mixing of a sheet of a different size, the mixing of a Z-folded sheet in a front cover or a back cover, and the mixing of a sheet of a different size in the front cover or the back cover when the sheet bundle 60 has a page structure that can hardly cause an alignment failure or a binding failure.

In the third embodiment, it is assumed that the serviceman performs the operation for relieving the inhibition of mixing of a Z-folded sheet or a sheet of a different size by logging in a service mode that can be accessed only by using a hidden command that is not notified to a user via a unit that is generally operated by the user, such as an operation panel, in the image forming system. Alternatively, the operation can be performed by changing settings of hardware, such as a dual in-line package switch (DIP SW) on a control board, in the apparatus.

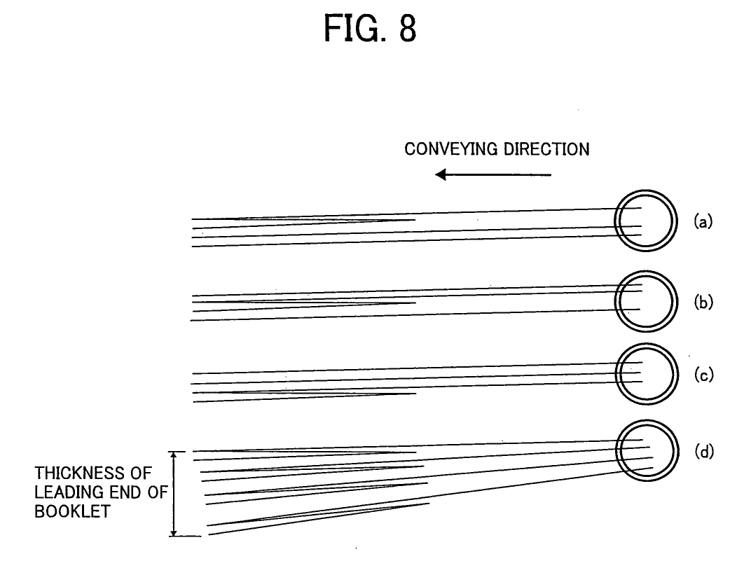

FIGS. 8A to 8D are schematic diagrams of examples of a ring-bound booklet that contains Z-folded sheets. Explanation about a booklet that may cause a problem because of contained Z-folded sheets is given below with reference to FIG. 8. In the example shown in (a) and (b) of FIG. 8, an end of the Z-folded sheet in the side to be unfolded is not on the top surface of the booklet. Therefore, if a thickness of the entire booklet is within a thickness that is conveyable, a paper jam or a paper twist can hardly occur. On the other hand, in the example shown in (c) of FIG. 8, an end of the Z-folded sheet in the side to be unfolded is brought into contact with the conveying path. Therefore, problems may occur such that the Z-folded sheet is turned over, a paper twisting occurs, or even a paper jam occurs depending on a weight of the booklet or thicknesses of sheets of the booklet. Furthermore, in the example shown in (d) of FIG. 8, a booklet is too thick, that is, a leading end of the booklet is so thick that the booklet cannot be conveyed.

When a Z-folded sheet is contained in a booklet, various factors, such as a position where the Z-folded sheet is contained, the number of pages in a booklet, or a sheet characteristic, can hardly be detected by an apparatus. Therefore, the image forming system according to the first to the third embodiments is configured such that mixing of a Z-folded sheet and a sheet of a different size is inhibited by default, and the inhibition of the mixing of the Z-folded sheet and a sheet of a different size are released based on a determination by an operator (user) depending on a structure of the booklet. In this manner, because the image forming system according to the first to the third embodiments has a function for enabling the user to set a selection, the booklet can be made more flexibly. On the other hand, when the image forming system is used by not only an operator who can make the above determination but also users who cannot make the above determination, it is possible to configure such that only a serviceman is allowed to change settings of the inhibition in a service mode and keys for enabling mixing of a Z-folded sheet and a sheet of a different size are hidden from an operation screen to be used by users.

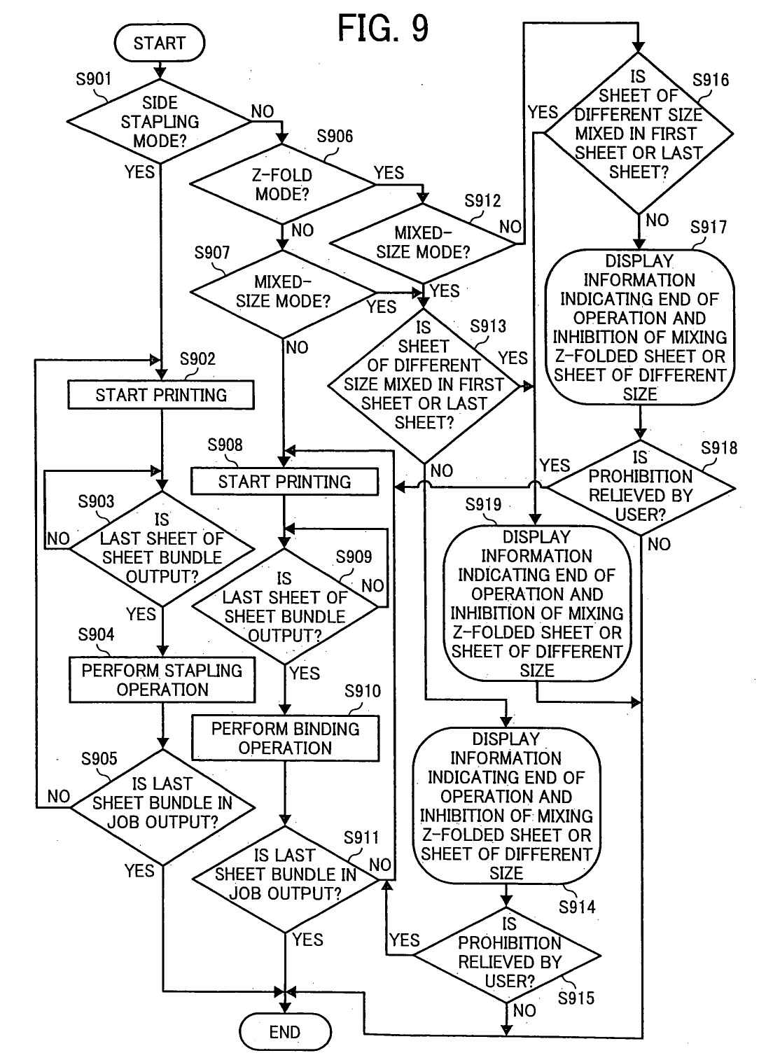

FIG. 9 is a flowchart of a process procedure according to a fourth embodiment of the present invention, in which a user releases an inhibition of Z-folding of a sheet and mixing of a sheet of a different size when a binding mode for tape binding, ring binding, or glue binding other than stapling is selected in the image forming system shown in FIG. 1. The process procedure is described in detail below with reference to FIG. 9.

The image forming apparatus 1 determines whether a side stapling mode is selected as a binding mode based on an input of a selection of the binding mode from a user via the operation panel 3 (Step S901). When determining that the selected binding mode is the side stapling mode (YES at Step S901), the image forming apparatus 1 starts a printing process (Step S902). The image forming apparatus 1 then determines whether a last sheet of a sheet bundle is output (Step S903). When determining that the last sheet of the sheet bundle is not output (NO at Step S903), process control remains at Step S903 and the printing process is repeated until the last sheet of the sheet bundle is output. When the last sheet of the sheet bundle is output (YES at Step S903), the sheet finisher 9 performs a stapling operation (Step S904). Then, the image forming apparatus 1 determines whether a last sheet bundle in a job is output (Step S905). When the last sheet bundle in the job is not output (NO at Step S905), the processes at Steps S902 to S904 are repeated until the last sheet bundle in the job is output. When the last sheet bundle in the job is output (YES at Step S905), the image forming system ends the operation.

On the other hand, when determining that the side stapling mode is not selected as the binding mode (NO at Step S901), the image forming apparatus 1 determines whether a Z-fold mode is selected (Step S906). When determining that the Z-fold mode is not selected (NO at Step S906), the image forming apparatus 1 determines whether a mixed-size mode is selected (Step S907). When determining that the mixed-size mode is not selected (NO at Step S907), the image forming apparatus 1 starts a printing process (Step S908).

When starting the printing process, the image forming apparatus 1 determines whether the last sheet of the sheet bundle is output (Step S909). When determining that the last sheet of the sheet bundle is not output (NO at Step S909), process control remains at Step S909 and the printing process is repeated until the last sheet of the sheet bundle is output. When the last sheet of the sheet bundle is output (YES at Step S909), a device for a corresponding binding operation performs the binding operation other than a side stapling operation (Step S910). Then, the image forming apparatus 1 determines whether the last sheet bundle in the job is output (Step S911). When the last sheet bundle in the job is not output (NO at Step S911), the processes at Steps S908 to S910 are repeated until the last sheet bundle in the job is output. When the last sheet bundle in the job is output (YES at Step S911), the image forming system ends the operation.

On the other hand, in the process at Step S907, when determining that the mixed-size mode is selected (YES at Step S907), the image forming apparatus 1 determines whether a sheet of a different size is mixed in a first sheet or a last sheet (a front cover or a back cover) (Step S913). When the sheet of the different size is not mixed in the first sheet or the last sheet (NO at Step S913), the image forming system ends the operation and displays information indicating an end of the operation by the image forming system and an inhibition of mixing of a sheet of a different size (Step S914). The image forming apparatus 1 displays a selection input screen for instructing a user to select whether to release an inhibition of the mixed-size mode on a display unit (not shown) so that the user is instructed to select whether to release the inhibition of the mixed-size mode (Step S915). When the user inputs the instruction for relieving the inhibition of the mixed-size mode (YES at Step S915), process control returns to Step S908, that is, the image forming apparatus 1 starts the printing process (Step S908). Then, the processes at Steps S909 to S911 are repeated in the same manner as described above. When the user does not input the instruction for relieving the inhibition of the mixed-size mode (NO at Step S915), the image forming system ends the operation.

In the process at Step S913, when determining that the sheet of the different size is mixed in the first sheet or the last sheet (YES at Step S913), the image forming system displays information indicating an end of the operation by the image forming system and an inhibition of mixing of the sheet of the different size (Step S919), and ends the operation.

When determining that the Z-fold mode is selected in the process at Step S906 (YES at Step S906), the image forming apparatus 1 determines whether the mixed-size mode is selected (Step S912). When determining that the mixed-size mode is not selected (NO at Step S912), the image forming system determines whether a Z-folded sheet is mixed in the first sheet or the last sheet (the front cover or the back cover) (Step S916). When the Z-folded is not mixed in the first sheet or the last sheet (NO at Step S916), the image forming system ends the operation and displays information indicating an end of the operation by the image forming system and an inhibition of mixing of a Z-folded sheet (Step S917).

Then, the image forming apparatus 1 displays a selection input screen for instructing the user to select whether to release an inhibition of the Z-fold mode on the display unit, so that the user is instructed to select whether to release the inhibition of the Z-fold mode (Step S918). When the user inputs the instruction for relieving the inhibition of the Z-fold mode (YES at Step S918), process control returns to Step S908, that is, the image forming apparatus 1 starts the printing process (Step S908). Then, the processes at Steps S909 to S911 are repeated in the same manner as described above. When the user does not input the instruction for relieving the inhibition of the Z-fold mode (NO at Step S918), the image forming system ends the operation.

In the process at Step S916, when determining that the Z-folded sheet is mixed in the first sheet or the last sheet (YES at Step S916), the image forming system displays information indicating an end of the operation by the image forming system and an inhibition of mixing of the Z-folded sheet (Step S919), and ends the operation.

On the other hand, in the process at Step S912, when determining that the mixed-size mode is selected (YES at Step S912), the image forming apparatus 1 determines whether a Z-folded sheet or a sheet of a different size is mixed in the first sheet or the last sheet (the front cover or the back cover) (Step S913). When the Z-folded sheet or the sheet of the different size is not mixed in the first sheet or the last sheet (NO at Step S513), the image forming system ends the operation and displays information indicating an end of the operation by the image forming system and an inhibition of mixing of a Z-folded sheet or a sheet of a different size (Step S914).

Then, the image forming apparatus 1 displays a selection input screen for instructing the user to select whether to release an inhibition of the Z-fold mode or the mixed-size mode on the display unit, so that the user is instructed to select whether to release the inhibition of the Z-fold mode or the mixed-size mode (Step S915). When the user inputs the instruction for relieving the inhibition of the Z-fold mode or the mixed-size mode (YES at Step S915), process control returns to Step S908, that is, the image forming apparatus 1 starts the printing process (Step S908). Then, the processes at Steps S909 to S911 are repeated in the same manner as described above. When the user does not input the instruction for relieving the inhibition of the Z-fold mode or the mixed-size mode (NO at Step S915), the image forming system ends the operation.

In the process at Step S913, when determining that the Z-folded sheet or the sheet of the different size is mixed in the first sheet or the last sheet (YES at Step S913), the image forming system displays information indicating an end of the operation by the image forming system and an inhibition of mixing of the Z-folded sheet and the sheet of the different size (Step S919), and ends the operation.

According to the fourth embodiment, when a user selects a binding mode for tape binding, ring binding, or glue binding other than stapling, and if a Z-folded sheet or a sheet of a different size is not mixed in the front cover or the back cover, the Z-folding of a normal sheet and mixing of a sheet of a different size are inhibited by default. However, the user can release the inhibition of mixing of various sheets through an operation for relieving the inhibition of the Z-folding of a sheet and mixing of a sheet of a different size. Therefore, it is possible to provide the image forming system with high functionalities that can enable the Z-folding of a sheet and the mixing of a sheet of a different size when the sheet bundle 60 has a page structure that can hardly cause an alignment failure or a binding failure.

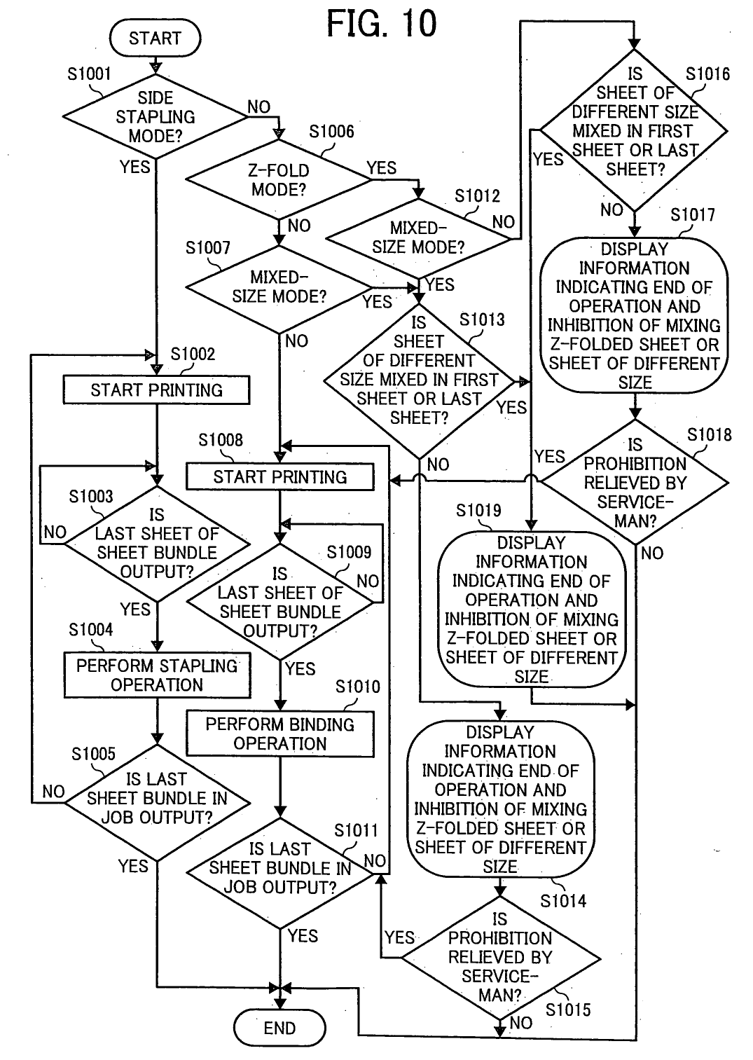

FIG. 10 is a flowchart of a process procedure according to a fifth embodiment of the present invention, in which a serviceman releases an inhibition of Z-folding of a sheet and mixing of a sheet of a different size when a binding mode for tape binding, ring binding, or glue binding other than stapling is selected in the image forming system shown in FIG. 1. The process procedure is described in detail below with reference to FIG. 10.

The image forming apparatus 1 determines whether a side stapling mode is selected as a binding mode based on an input of a selection of the binding mode from a user via the operation panel 3 (Step S1001). When determining that the selected binding mode is the side stapling mode (YES at Step S1001), the image forming apparatus 1 starts a printing process (Step S1002). The image forming apparatus 1 then determines whether a last sheet of a sheet bundle is output (Step S1003). When determining that the last sheet of the sheet bundle is not output (NO at Step S1003), process control remains at Step S1003 and the printing process is repeated until the last sheet of the sheet bundle is output. When the last sheet of the sheet bundle is output (YES at Step S1003), the sheet finisher 9 performs a stapling operation (Step S1004). Then, the image forming apparatus 1 determines whether a last sheet bundle in a job is output (Step S1005). When the last sheet bundle in the job is not output (NO at Step S1005), the processes at Steps S1002 to S1004 are repeated until the last sheet bundle in the job is output. When the last sheet bundle in the job is output (YES at Step S1005), the image forming system ends the operation.

On the other hand, when determining that the side stapling mode is not selected as the binding mode (NO at Step S1001), the image forming apparatus 1 determines whether a Z-fold mode is selected (Step S1006). When determining that the Z-fold mode is not selected (NO at Step S0106), the image forming apparatus 1 determines whether a mixed-size mode is selected (Step S1007). When determining that the mixed-size mode is not selected (NO at Step S1007), the image forming apparatus 1 starts a printing process (Step S1008).

When starting the printing process, the image forming apparatus 1 determines whether the last sheet of the sheet bundle is output (Step S1009). When determining that the last sheet of the sheet bundle is not output (NO at Step S1009), process control remains at Step S1009 and the printing process is repeated until the last sheet of the sheet bundle is output. When the last sheet of the sheet bundle is output (YES at Step S1009), a device for a corresponding binding operation performs the binding operation other than a side stapling operation (Step S1010). Then, the image forming apparatus 1 determines whether the last sheet bundle in the job is output (Step S1011). When the last sheet bundle in the job is not output (NO at Step S1011), the processes at Steps S1008 to S1010 are repeated until the last sheet bundle in the job is output. When the last sheet bundle in the job is output (YES at Step S1011), the image forming system ends the operation.

On the other hand, in the process at Step S1007, when determining that the mixed-size mode is selected (YES at Step S1007), the image forming apparatus 1 determines whether a sheet of a different size is mixed in a first sheet or a last sheet (Step S1013). When the sheet of the different size is not mixed in the first sheet or the last sheet (NO at Step S1013), the image forming system ends the operation and displays information indicating an end of the operation by the image forming system and an inhibition of mixing of a sheet of a different size (Step S1014). Then, the image forming apparatus 1 instructs a serviceman to select whether to release an inhibition of the mixed-size mode (Step S1015). When the serviceman inputs an instruction for relieving the inhibition of the mixed-size mode (YES at Step S1015), process control returns to Step S1008, that is, the image forming apparatus 1 starts the printing process (Step S1008). Then, the processes at Steps S1009 to S1011 are repeated in the same manner as described above. When the serviceman does not input the instruction for relieving the inhibition of the mixed-size mode (NO at Step S1015), the image forming system ends the operation.

In the process at Step S1013, when determining that the sheet of the different size is mixed in the first sheet or the last sheet (YES at Step S1013), the image forming system displays information indicating an end of the operation by the image forming system and an inhibition of mixing of the sheet of the different size (Step S1019), and ends the operation.

When determining that the Z-fold mode is selected in the process at Step S1006 (YES at Step S1006), the image forming apparatus 1 determines whether the mixed-size mode is selected (Step S1012). When determining that the mixed-size mode is not selected (NO at Step S1012), the image forming system determines whether a Z-folded sheet is mixed in the first sheet or the last sheet (the front cover or the back cover) (Step S1016). When the Z-folded is not mixed in the first sheet or the last sheet (NO at Step S1016), the image forming system ends the operation and displays information indicating an end of the operation by the image forming system and an inhibition of mixing of a Z-folded sheet (Step S1017).

Then, the image forming apparatus 1 instructs the serviceman to select whether to release an inhibition of the Z-fold mode (Step S1018). When the serviceman inputs an instruction for relieving the inhibition of the Z-fold mode (YES at Step S1018), process control returns to Step S1008, that is, the image forming apparatus 1 starts the printing process (Step S1008). Then, the processes at Steps S1009 to S1011 are repeated in the same manner as described above. When the serviceman does not input the instruction for relieving the inhibition of the Z-fold mode (NO at Step S1018), the image forming system ends the operation.

In the process at Step S1016, when determining that the Z-folded sheet is mixed in the first sheet or the last sheet (YES at Step S1016), the image forming system displays information indicating an end of the operation by the image forming system and an inhibition of mixing of the Z-folded sheet (Step S1019), and ends the operation.

On the other hand, in the process at Step S1012, when determining that the mixed-size mode is selected (YES at Step S1012), the image forming apparatus 1 determines whether a Z-folded sheet or a sheet of a different size is mixed in the first sheet or the last sheet (the front cover or the back cover) (Step S1013). When the Z-folded sheet or the sheet of the different size is not mixed in the first sheet or the last sheet (NO at Step S1013), the image forming system ends the operation and displays information indicating an end of the operation by the image forming system and an inhibition of mixing of a Z-folded sheet or a sheet of a different size (Step S1014).

Then, the image forming apparatus 1 instructs the serviceman to select whether to release an inhibition of the Z-fold mode or the mixed-size mode (Step S1015). When the serviceman inputs the instruction for relieving the inhibition of the Z-fold mode or the mixed-size mode (YES at Step S1015), process control returns to Step S1008, that is, the image forming apparatus 1 starts the printing process (Step S1008). Then, the processes at Steps S1009 to S1011 are repeated in the same manner as described above. When the serviceman does not input the instruction for relieving the inhibition of the Z-fold mode or the mixed-size mode (NO at Step S1015), the image forming system ends the operation.

In the process at Step S1013, when determining that the Z-folded sheet or the sheet of the different size is mixed in the first sheet or the last sheet (YES at Step S1013), the image forming system displays information indicating an end of the operation by the image forming system and an inhibition of mixing of the Z-folded sheet and the sheet of the different size (Step S1019), and ends the operation.

According to the fifth embodiment, when a binding mode for tape binding, ring binding, or glue binding other than stapling is selected, and if a Z-folded sheet or a sheet of a different size is not mixed in the front cover or the back cover, the Z-folding of a normal sheet and mixing of a sheet of a different size are inhibited by default. However, the serviceman can release the inhibition of mixing of various sheets through an operation for relieving the inhibition of the Z-folding of a sheet and mixing of a sheet of a different size. Therefore, it is possible to provide the image forming system with high functionalities that can enable the Z-folding of a sheet and the mixing of a sheet of a different size when the sheet bundle 60 has a page structure that can hardly cause an alignment failure or a binding failure.

The present invention is not limited to the first to the fifth embodiments described above, in which examples of the processes for inhibiting and relieving the inhibition of Z-folding of a sheet, mixing of a sheet of a different size, mixing of a Z-folded sheet in the front cover or the back cover, and mixing of a sheet of a different size in the front cover or the back cover are described.

According to one aspect of the present invention, when a user selects a binding mode for tap binding, ring binding, or glue binding other than stapling, z-folding of a sheet is inhibited. Therefore, a sheet alignment failure or a sheet stapling failure can be prevented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming system that has at least one binding mode for binding sheets to make a booklet, the image forming system comprising:
an image forming apparatus that forms an image on a sheet, the image forming apparatus including an operating unit that receives an input of a binding mode;
a Z-folding device including a Z-folding unit that folds a sheet into Z-fold depending on an input binding mode;
a sheet post processing device including a binding unit that performs a stapling process on sheets depending on the input binding mode; and
at least one binding device including a binding unit that performs a binding process other than the stapling process on the sheets depending on the input binding mode, wherein
the image forming apparatus further includes a control unit that, when it is determined that the input binding mode is a binding mode corresponding to a binding process other than the stapling process, inhibits the Z-folding unit from folding a sheet into Z-fold.

2. The image forming system according to claim 1, wherein when it is determined that the input binding mode is a binding mode corresponding to a binding process other than the stapling process, the control unit inhibits the Z-folding unit from folding a front cover and a back cover of the booklet into Z-fold.

3. The image forming system according to claim 1, wherein
when it is determined that the input binding mode is a binding mode corresponding to a binding process other than the stapling process, the operating unit receives a release input about whether to release an inhibition of Z-folding of a sheet by the Z-folding unit, and
the Z-folding unit folds a sheet into Z-fold depending on the release input.

4. The image forming system according to claim 1, wherein when it is determined that the input binding mode is a binding mode corresponding to a binding process other than the stapling process, the control unit further inhibits mixing of sheets of a different sizes.

5. The image forming system according to claim 1, wherein when it is determined that the input binding mode is a binding mode corresponding to a binding process other than the stapling process, the control unit further inhibits mixing of sheets of different sizes for a front cover and a back cover of the booklet.

6. The image forming system according to claim 4, wherein
when it is determined that the input binding mode is a binding mode corresponding to a binding process other than the stapling process, the operating unit receives a release input about whether to release an inhibition of mixing of the sheets of different sizes, and
the control unit mixes the sheets of a different sizes depending on the release input.

7. The image forming system according to claim 5, wherein
when it is determined that the input binding mode is a binding mode corresponding to a binding process other than the stapling process, the operating unit receives a release input about whether to release an inhibition of mixing of the sheets of different sizes for the front cover and the back cover of the booklet, and
the control unit mixes the sheets of a different sizes for the front cover and the back cover of the booklet depending on the release input.

8. The image forming system according to claim 1, wherein the binding unit binds the sheets with a ring.

9. An image forming apparatus comprising:
an operating unit that receives an input of a binding mode; and
an image forming unit that forms an image on a sheet, wherein
the image forming apparatus is connected to a Z-folding device, a sheet post processing device, and at least one binding device,
the Z-folding device includes a Z-folding unit that folds a sheet into Z-fold,
the sheet post processing device includes a binding unit that performs a stapling process on sheets,
the binding device includes a binding unit that performs a binding process other than the stapling process on the sheets depending on an input binding mode,
the image forming apparatus further comprises a control unit that controls the Z-folding device, the sheet post processing device, and the binding device depending on the input binding mode, and
when it is determined that the input binding mode is a binding mode corresponding to a binding process other than the stapling process, the control unit inhibits the Z-folding unit from folding a sheet into Z-fold.

10. The image forming apparatus according to claim 9, wherein when it is determined that the input binding mode is a binding mode corresponding to a binding process other than the stapling process, the control unit inhibits the Z-folding unit from folding a front cover and a back cover of the booklet into Z-fold.

11. The image forming apparatus according to claim 9, wherein
when it is determined that the input binding mode is a binding mode corresponding to a binding process other than the stapling process, the operating unit receives a release input about whether to release an inhibition of Z-folding of a sheet by the Z-folding unit, and
the Z-folding unit folds a sheet into Z-fold depending on the release input.

12. The image forming apparatus according to claim 9, when it is determined that the input binding mode is a binding mode corresponding to a binding process other than the stapling process, the control unit further inhibits mixing of sheets of a different sizes.

13. The image forming apparatus according to claim 9, wherein when it is determined that the input binding mode is a binding mode corresponding to a binding process other than the stapling process, the control unit further inhibits mixing of sheets of different sizes for a front cover and a back cover of the booklet.

14. The image forming apparatus according to claim 12, wherein
when it is determined that the input binding mode is a binding mode corresponding to a binding process other than the stapling process, the operating unit receives a release input about whether to release an inhibition of mixing of the sheets of different sizes, and
the control unit mixes the sheets of a different sizes depending on the release input.

15. The image forming apparatus according to claim 13, wherein
when it is determined that the input binding mode is a binding mode corresponding to a binding process other than the stapling process, the operating unit receives a release input about whether to release an inhibition of mixing of the sheets of different sizes for the front cover and the back cover of the booklet, and
the control unit mixes the sheets of a different sizes for the front cover and the back cover of the booklet depending on the release input.

16. The image forming apparatus according to claim 9, wherein the binding unit binds the sheets with a ring.
